(19) United States
(12) Patent Application Publication
(10) Pub. No.: US 2008/0129832 A1
(43) Pub. Date: Jun. 5, 2008

(54) Imaging Device

(75) Inventor: Hiroki MATSUBARA, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/948,312

(22) Filed: Nov. 30, 2007

(30) Foreign Application Priority Data
Nov. 30, 2006 (JP) 2006-324199

(51) Int. Cl. H04N 5/228

(52) U.S. Cl. 348/208.99; 348/E05.024

(57) ABSTRACT

An imaging device comprising an image sensor, a shutter release button, and a microcontroller. On detecting that the shutter release button is pressed, the microcontroller calculates camera shake cycle based on both displacement per unit time of an attention area between each taken image and the time when the each image was taken. Based on the calculated camera shake cycle, the microcontroller controls timing of imaging so as to take an image at the time when effect of the camera shake is at a minimum. Thus, the imaging device can reduce the effect on the image caused by the camera shake without a sensor only for detecting the camera shake, as compared to the conventional imaging device.

### BACKGROUND OF THE INVENTION

1. Field of the Invention

The present invention relates to an imaging device, and more particularly relates to a technology to obtain an image from which effect of a camera shake is reduced.

2. Description of the Related Art

Conventionally, a digital still camera takes an image by making an image sensor receive light from a subject for a given time period. When a user moves the digital still camera during taking the image, a position of a subject image on the image sensor is moved from its original position. For this reason, the taken image is sometimes blurred. This phenomenon is called a camera shake phenomenon.

In view of the above problem, Japanese laid-open patent publication No. Hei 3-273221 discloses an imaging device (a digital still camera) that comprises an angular velocity sensor and a circuit for controlling the angular velocity sensor in order to detect the camera shake. However, this imaging device has a problem that it is difficult to reduce its production cost because it requires the above described angular velocity sensor and the circuit for controlling the angular velocity sensor.

Japanese laid-open patent publication No. Hei 7-43803 discloses an imaging device comprising an optical sensor for detecting displacement of the subject image on the image sensor caused by the camera shake. However, this imaging device has a problem that it is difficult to reduce its production cost because it requires the above described optical sensor.

### SUMMARY OF THE INVENTION

An object of the present invention is to provide an imaging device that can reduce not only the effect on the image caused by the camera shake with a simple circuit structure but also its production cost, as compared to the above-described conventional imaging device.

According to an aspect of the present invention, this object is achieved by an imaging device comprising: an image sensor for receiving and converting light from a subject into electronic signals; image conversion means for converting the electronic signals converted by the image sensor into images; operating means having a shutter release button; control means for controlling each component in the imaging device; camera shake cycle calculating means for calculating camera shake cycle based on both displacement per unit time of an attention area between each image converted by the image conversion means and the time when the each image was taken; and imaging timing control means for controlling timing of imaging so as to take an image at the time when effect of the camera shake is at a minimum, based on the camera shake cycle calculated by the camera shake cycle calculating means.

With the above configuration, imaging timing control means controls timing of imaging so as to take an image at the time when effect of the camera shake is at a minimum based on the calculated camera shake cycle. Thus, the imaging device can reduce the effect on the image caused by the camera shake without a sensor only for detecting the camera shake, as compared to the conventional imaging device. Therefore, the imaging device can reduce not only the effect on the image caused by the camera shake with a simple circuit structure but also its production cost, as compared to the conventional imaging device.

Preferably, the imaging device further comprises shutter release button detection means for detecting whether the shutter release button is pressed, and the camera shake cycle calculating means calculates the camera shake cycle when the shutter release button detection means detects that the shutter release button is pressed.

More preferably, the operating means further has a mode switching button for switching on/off of the image stabilization mode, and the camera shake cycle calculating means calculates the camera shake cycle when the shutter release button detection means detects that the shutter release button is pressed, in a state where the mode switching button is previously set on so as to switch on the image stabilization mode.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1A is a front elevation of an imaging device according to one embodiment of the present invention;

FIG. 1B is a back elevation of the imaging device;

FIG. 2 is a block diagram showing the internal configuration of the imaging device;

FIG. 3 is a diagram showing how a user presses a shutter release button of the imaging device;

FIG. 4A is a diagram showing the shutter release button in a state where it is not pressed;

FIG. 4B is a diagram showing the shutter release button in a state where it is pressed halfway;

FIG. 4C is a diagram showing the shutter release button in a state where it is pressed all the way down;

FIG. 5 is a flowchart showing the steps of a imaging process in the imaging device;

FIG. 6 is a flowchart showing the steps of a camera shake cycle analysis process in the imaging process;

FIG. 7 is a diagram showing attention areas to be used in the camera shake cycle analysis process; and

FIG. 8 is a diagram showing an example of a wave of the camera shake cycle.

### DESCRIPTION OF THE PREFERRED EMBODIMENTS

Referring now to the accompanying drawings, an imaging device embodying the present invention is described. It is to be noted that the following description of preferred embodiment of the present invention has been presented for purposes of illustration and description, and is not intended to be exhaustive or to limit the present invention to the precise form disclosed.

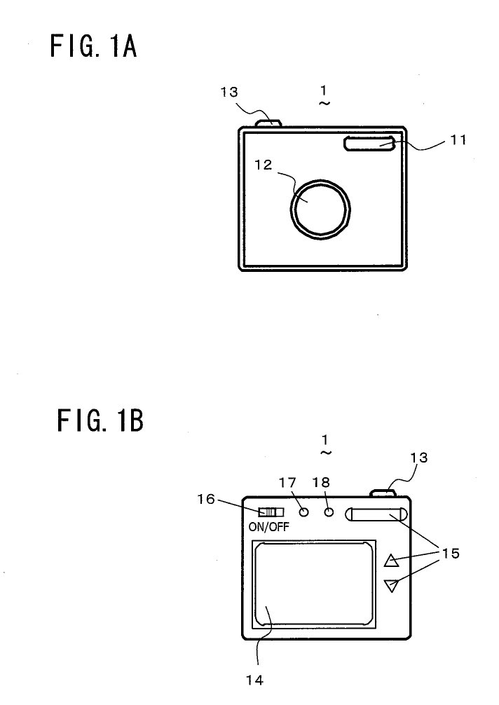

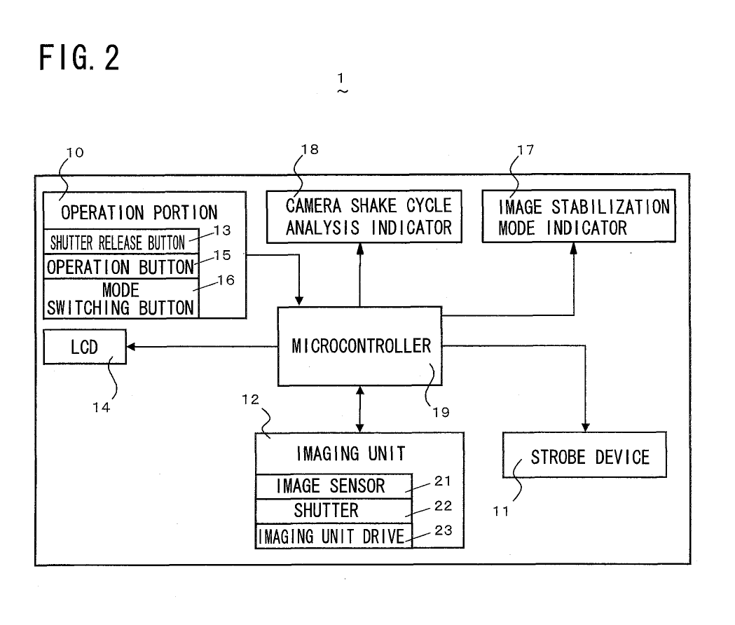

FIG. 1A shows a front surface of an imaging device 1 according to one embodiment of the present invention. FIG. 1B shows a back surface of the imaging device 1. FIG. 2 shows the configuration of the imaging device 1. The imaging device 1 comprises: a strobe device 11 for emitting strobe light in order to enable the imaging device 1 to take an image at night or indoors; an imaging unit 12 for imaging a subject; a liquid crystal display (LCD) 14 for displaying the image taken by the device and various messages; an operation portion 10 (claimed operation means) having operation buttons for operating the imaging device 1 and the like; an image stabilization mode indicator 17 for indicating that the imaging device 1 has entered image stabilization mode (has been ready to reduce the effect on the image caused by the camera shake); a camera shake cycle analysis indicator 18 for indicating that a microcontroller 19 (control means) is analyzing the camera shake cycle; and the microcontroller 19 for controlling each component in the imaging device 1.

The imaging unit 12 comprises an image sensor 21 for receiving and converting light from a subject into electronic signals; a shutter 22 which is opened and shut in order to limit the amount of light which enters the image sensor 21; and an imaging unit drive 23 for getting each component in the imaging unit 12 to work. The operation portion 10 has operation buttons 15 for operating each component in the imaging device 1, a mode switching button 16 for switching on/off of the image stabilization mode, and a shutter release button 13 which acts as a trigger for opening and shutting the shutter 22. The user can press the shutter release button 13 halfway or all the way down for his purpose.

The microcontroller 19 functions as control means, shutter release button detection means, camera shake cycle calculating means, and imaging timing control means recited in the claims. As shown in FIG. 1A, the strobe device 11 and the imaging unit 12 are disposed on the front surface of the imaging device 1. As shown in FIG. 1B, the liquid crystal display 14, the operation buttons 15, the mode switching button 16, the image stabilization mode indicator 17, and the camera shake cycle analysis indicator 18 are disposed on the back surface of the imaging device 1. As shown in FIG. 1A and FIG. 1B, the shutter release button 13 is disposed on the upper surface of the imaging device 1. The microcontroller 19 and the liquid crystal display 14 functions as image conversion means.

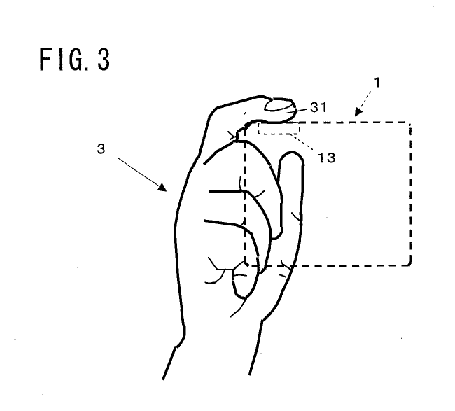

As shown in FIG. 3, the user usually presses the shutter release button 13 with his or her forefinger 31 with holding the imaging device 1 in his or her hand 3. Accordingly, when the user moves the hand 3, a position of the imaging device 1 is moved from its original position. If the position of the imaging device 1 is moved while the shutter 22 is opened, the camera shake (phenomenon) occurs. Note that the human body naturally has cyclic oscillation.

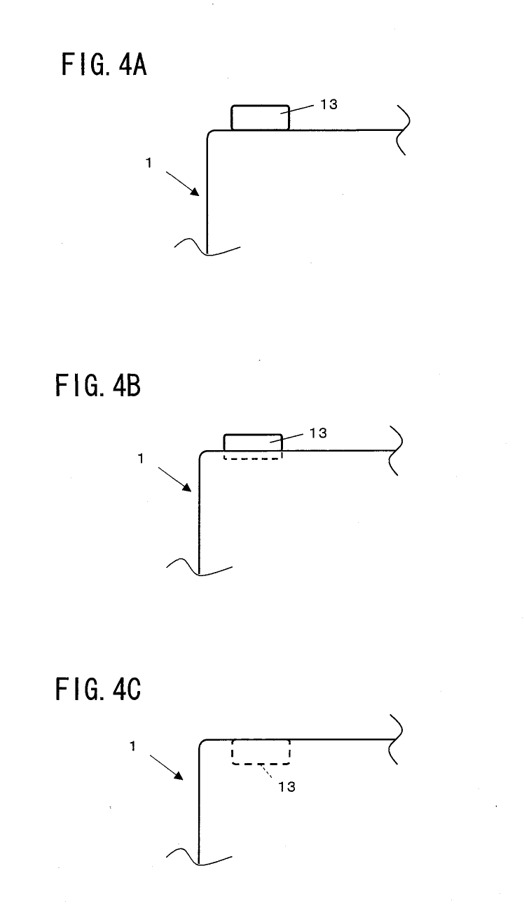

FIG. 4A shows the shutter release button 13 in a state where it is not pressed. FIG. 4B shows the shutter release button 13 in a state where it is pressed halfway. FIG. 4C shows the shutter release button 13 in a state where it is pressed all the way down. When the shutter release button 13 is pressed halfway as shown in FIG. 4B, the microcontroller 19 instructs the imaging unit drive 23 to adjust the focus of the optical system (not shown) on the subject. When the shutter release button 13 is pressed all the way down after being pressed halfway as described above, the microcontroller 19 starts imaging the subject with keeping the focal position of the above-described optical system.

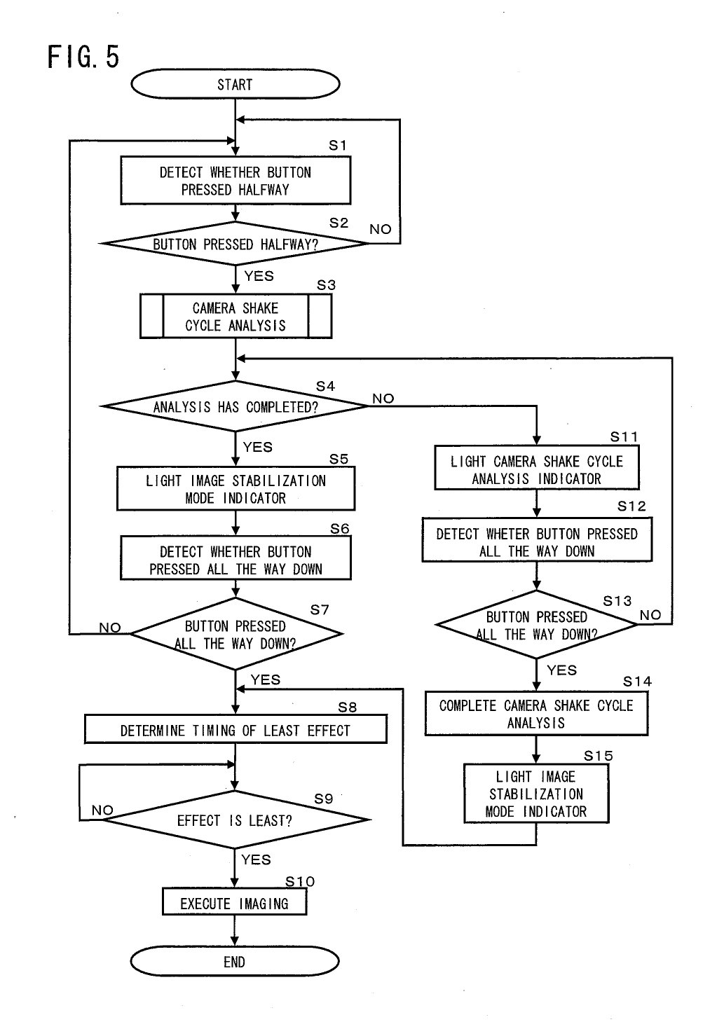

Referring now to FIG. 5, the process executed by the microcontroller 19 in imaging the subject is described below. Let us assume that the mode switching button 16 is previously set on so as to switch on the image stabilization mode. The microcontroller 19 detects whether the shutter release button 13 is pressed halfway (S1). When it has been detected that the shutter release button 13 is pressed halfway by the user (YES at S2), the microcontroller 19 analyzes the camera shake cycle (S3). The camera shake cycle analysis process will be described in detail below.

When the microcontroller 19 has completed the camera shake cycle analysis process (YES at S4), the microcontroller 19 lights the image stabilization mode indicator 17 (S5). Subsequently, the microcontroller 19 detects whether the shutter release button 13 is pressed all the way down (S6). On detecting that the shutter release button 13 is pressed all the way down by the user (YES at S7), the microcontroller 19 determines the timing when the effect of the camera shake is the least (S8), based on the result of the camera shake cycle analysis at the step S3. At this timing when the effect of the camera shake is the least (YES at S9), the microcontroller 19 executes imaging (S10). When the shutter release button 13 is not pressed all the way down by the user (NO at S7), the microcontroller 19 repeats the step S1 to S6.

While analyzing the camera shake cycle (NO at S4), the microcontroller 19 detects whether the shutter release button 13 is pressed all the way down (S12) after lighting the camera shake cycle analysis indicator 18 (S11). When detecting that the shutter release button 13 is pressed all the way down by the user (YES at S13), the microcontroller 19 turns off the camera shake cycle analysis indicator 18 after completing the camera shake cycle analysis process (S14). Subsequently, the microcontroller 19 performs the above step S8 to S10 after lighting the image stabilization mode indicator 17 (S15).

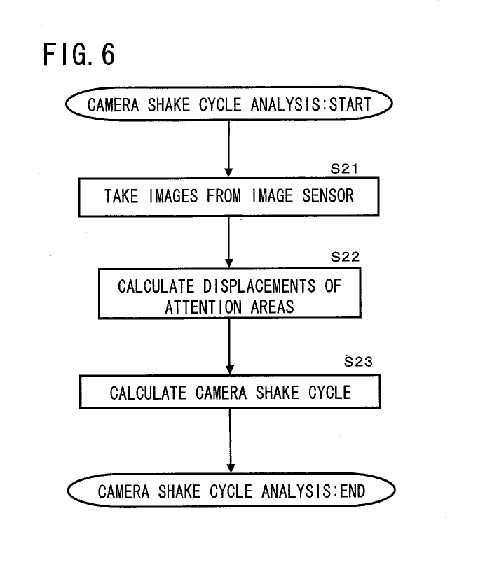

Referring now to FIG. 6 to FIG. 8, the camera shake cycle analysis process is described in detail below. As shown in FIG. 6, the microcontroller 19 takes images from the image sensor 21 (S21). The microcontroller 19 calculates the displacements per unit time of attention areas, based on both the displacements of attention areas between each taken image and the time when the each image was taken (S22). Subsequently, the microcontroller 19 calculates the camera shake cycle based on the fluctuation of the above-described displacements per unit time of the attention areas (S23).

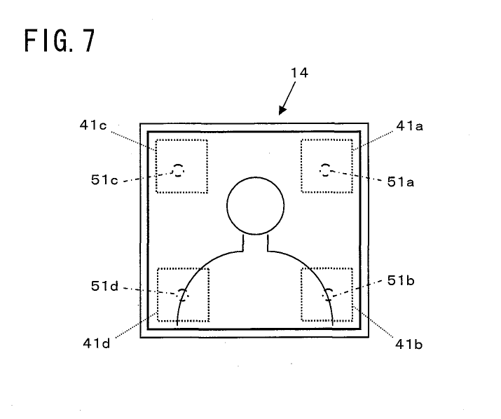

Referring now to FIG. 7, the calculation process of the displacements per unit time of the attention areas at the step S22 is described in detail below. As shown in FIG. 7, the microcontroller 19 calculates the displacements per unit time of attention areas 51a to 51d in the four corners of each image displayed on the liquid crystal display 14. The attention areas 51a to 51d are remarkable points, characteristic patterns, image contours or the like on image areas 41a to 41d in the four corners of each image. When the displacements per unit time of all the attention areas 51a to 51d between two sequential images are in the same direction, the microcontroller 19 determines that the displacements were caused by the camera shake. On the other hand, when the direction of displacement of one attention area 51a, 51b, 51c or 51d between two sequential images is different from that of other attention area between these two sequential images, the microcontroller 19 determines that the displacement was caused by the movement of the subject whose image is on any of the attention areas 51a to 51d. For example, when only the displacement of the attention area 51a has occurred in one direction on the image, the microcontroller 19 determines that the displacement was caused by the movement of the subject whose image is on the attention areas 51a.

Note that this embodiment shows the case where the four attention areas 51a to 51d are disposed on image areas 41a to 41d in the four corners of each image. However, the number of the attention areas is not limited to four. Furthermore, the positions of the attention areas are not limited to the corners of the image. The positions of the attention areas may be arbitrary positions on the each image.

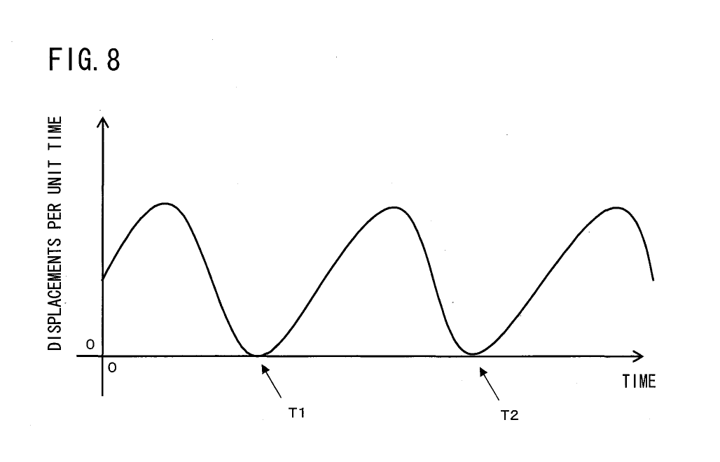

Referring now to FIG. 8, the camera shake cycle calculation process at the step S23 is described below. FIG. 8 shows an example of a wave of a calculated camera shake cycle. The vertical axis in the graph shown in FIG. 8 shows the displacements per unit time of attention areas 51a to 51d caused by the camera shake. The horizontal axis in the graph shows the time. For example, in the wave of the camera shake cycle shown in FIG. 8, the displacements per unit time of attention areas 51a to 51d caused by the camera shake are at a minimum at time Tk (k=1, 2, 3, . . . , n). Accordingly, at the step S8 in FIG. 5, the microcontroller 19 determines whether the present time is the time Tk (the time when the effect of the camera shake is at a minimum) so as to take an image at the time Tk.

As described above, according to the imaging device 1 embodying the present invention, the microcontroller 19 controls the timing of imaging so as to take an image at the time when the effect of the camera shake is at a minimum based on the calculated camera shake cycle. Thus, the imaging device 1 can reduce the effect on the image caused by the camera shake without a sensor only for detecting the camera shake as compared to the conventional imaging device. Therefore, the imaging device 1 can reduce not only the effect on the image caused by the camera shake with a simple circuit structure but also its production cost, as compared to the conventional imaging device.

The present invention has been described above using a presently preferred embodiment, but those skilled in the art will appreciate that various modifications are possible. For example, in the above described embodiment, the microcontroller analyzes the camera shake cycle, when the shutter release button is pressed halfway. However, the microcontroller may analyze the camera shake cycle when the shutter release button is pressed all the way down. Alternatively, he microcontroller may start analyzing the camera shake cycle when the shutter release button is pressed halfway, and then continue analyzing the camera shake cycle even after the shutter release button is pressed all the way down.

This application is based on Japanese patent application 2006-324199 filed Nov. 30, 2006, the contents of which are hereby incorporated by reference.

What is claimed is:

1. An imaging device comprising:
an image sensor for receiving and converting light from a subject into electronic signals;
image conversion means for converting the electronic signals converted by the image sensor into images;
operating means having a shutter release button;
control means for controlling each component in the imaging device;
camera shake cycle calculating means for calculating camera shake cycle based on both displacement per unit time of an attention area between each image converted by the image conversion means and the time when the each image was taken; and
imaging timing control means for controlling timing of imaging so as to take an image at the time when effect of the camera shake is at a minimum, based on the camera shake cycle calculated by the camera shake cycle calculating means.

2. The imaging device according to claim 1, further comprising shutter release button detection means for detecting whether the shutter release button is pressed,
wherein the camera shake cycle calculating means calculates the camera shake cycle when the shutter release button detection means detects that the shutter release button is pressed.

3. The imaging device according to claim 1, further comprising shutter release button detection means for detecting whether the shutter release button is pressed,
wherein the operating means further has a mode switching button for switching on/off of the image stabilization mode,
the camera shake cycle calculating means calculates the camera shake cycle when the shutter release button detection means detects that the shutter release button is pressed, in a state where the mode switching button is previously set on so as to switch on the image stabilization mode.
